(19) United States
(12) Patent Application Publication
(10) Pub. No.: US 2010/0141532 A1
(43) Pub. Date: Jun. 10, 2010

(54) ANTENNA FEEDING ARRANGEMENT

(76) Inventors: Jesper Uddin, Stockholm (SE); Annika Hu, Akersberga (SE)

Correspondence Address: David L. Henty, P.O. Box 3529, Newport Beach, CA, 92659, US

(21) Appl. No.: 12/624,305

(22) Filed: Nov. 23, 2009

Related U.S. Application Data
(63) Continuation-in-part of application No. 12/392,007, filed on Feb. 24, 2009.
(60) Provisional application No. 61/031,325, filed on Feb. 25, 2008.

(51) Int. Cl. H01Q 9/04

(52) U.S. Cl. 343/700 MS

(57) ABSTRACT

A dual polarized aperture coupled patch antenna element, including at least one antenna patch and a feeding arrangement, wherein said feeding arrangement comprises:

a ground plane including: a first aperture slot and a second aperture slot, where said aperture slots cross each other perpendicularly;

a feeding plane of sheet metal including:
a first antenna port for feeding microwave energy via a first feeding junction into a first pair of feed lines which extend in parallel along said first aperture slot, on each side thereof;
a second antenna port for feeding microwave energy via a second feeding junction into a second pair of feed lines which extend in parallel along said second aperture slot, on each side thereof. The antenna element is distinguished in that said feed lines cross each other at a mutual distance in more than one point.

### RELATED APPLICATION INFORMATION

This application is a continuation in part of U.S. patent application Ser. No. 12/392,007, filed Feb. 24, 2009, which claims the benefit under 35 U.S.C. §119(e) of U.S. Provisional Application Ser. No. 61/031,325, filed Feb. 25, 2008, the disclosures of which are incorporated herein by reference.

### FIELD OF THE INVENTION

The present invention relates to aperture antennas; in particular of the dual polarized aperture coupled patch antenna type.

### BACKGROUND OF THE INVENTION

Aperture antennas, such as for example slots, horns and aperture coupled patch antennas, are quite different in nature compared to dipole antennas. For example, in an aperture antenna, the electromagnetic radiation may be viewed as emanating from an aperture in a conducting enclosure. In the case of an aperture-coupled patch antenna the radiating patches are not conductively connected to the feeding arrangement, but excited by fields from an aperture.

In contrast to this, a dipole antenna consists of two dipole arms conductively connected to the feedline, often via a balun. Furthermore, the radiation from an aperture antenna and a dipole, respectively, is totally different in their characteristics.

The use of aperture antenna and dipole antennas, respectively, thus entails altogether different problems, and entails in particular totally different construction design aspects.

Basically, a typical aperture antenna, or aperture radiator, comprises a waveguide (antenna feed line) at the end of which an aperture is placed. A reflector may be used to accentuate certain desired radiation characteristics. An example of an antenna based on the aperture antenna technique is an aperture coupled patch antenna.

In accordance with the state of the art, a typical aperture coupled patch antenna comprises a dielectric laminate, for example a PCB (Printed Circuit Board). A feeding network, including an aperture feed feeding the antenna elements, is provided on one side of said PCB, typically by means of etching. The laminate is further provided with an electrically conductive layer on the opposite side serving as a ground plane for the aperture feed. The conductive layer may also serve as the ground plane for the antenna. The distance between the feeding network and the ground plane is thus fixed, whereby the antenna characteristics are reliable and predictable.

However, the use of laminate, such as PCB, is very expensive, especially considering that the laminate should be made as thin as possible in order to reduce the amount of dielectric losses. Further, the use of laminate with an etched-on feeding network requires several manufacturing steps. There is, for example, a lot of soldering steps required, which besides the laborious work, causes other problems such as giving undesired intermodulation effects. Further still, the step of attaching the ground layer to the reflector may also be a rather tedious and time-consuming manufacturing step.

A known solution to this problem is to form the aperture feed of a sheet metal element. Such sheet metal element may be punched out, etched, water cut, milled or laser cut or the like. Thereby a non-expensive, but still efficient and reliable aperture feed is provided, which is easy to manufacture.

In FIG. 1, such a prior art antenna employing a feed of sheet metal is shown during assembly, in FIG. 2 the feeds and the apertures are shown and in FIG. 3 the same configuration as in FIG. 2 is shown in a more conceptual representation:

The known antenna comprises an aperture antenna element 11 with a reflector 12, which is made of an electrically conductive material. The reflector 12 also serves as the ground plane for the aperture feed and comprises one or more apertures 13, which may be formed by punching, water cutting, laser cutting, etc. Further, an aperture feed 14 is fastened to the reflector 12, by means of distance elements 15, made of a non-conducting material such as plastic.

The aperture feed 14 is a conducting element suitable for feeding power to the aperture(s) 13, for example a sheet metal element or a metalized plastic. The aperture feed 14 can be produced as above by punching, water cutting, laser cutting, etc. When the aperture antenna 11 is used together with a patch, it forms an aperture-coupled patch antenna.

As is shown in the figure, a pair of rectilinear slots 13 oriented at right angles to each other is provided, so as to facilitate double polarization operation.

The aperture feed 14 is fork-shaped, in order to be able to feed both aperture 13 slots in an efficient manner.

As is outlined in the figure, the aperture feeds 14, 14′ are placed on top of each other, however without being in contact to each other. The uppermost aperture feed 14 should thus have a shape permitting such configuration; more specifically, the aperture feed 14 that is placed on top of another aperture feed 14′ should have some kind of curvature so that the bottom aperture feed 14′ find room underneath the uppermost aperture feed 14, without them being in contact with each other.

### SUMMARY OF THE INVENTION

Even though cheaper manufacturing may be achieved with a feed of sheet metal described above, there have been problems with the performance of such designs. Thus, it has been hard to achieve desired specifications on parameters such as Return loss and Isolation when using such sheet metal. Return loss is the power reflected back from the element due to mismatch and Isolation is the isolation between the two channels, i.e. the coupling between the two channels.

It is an object of the present invention to propose a solution for or a reduction of the problems of prior art. A main object is consequently to devise an antenna feeding arrangement that can meet desired specification parameters.

The solution to the problem is provided by the invention in accordance with a dual polarized aperture coupled patch antenna element, including at least one antenna patch and a feeding arrangement, wherein said feeding arrangement comprises:
a ground plane including: a first aperture slot and a second aperture slot, where said aperture slots cross each other perpendicularly;
a feeding plane comprising sheet metal and including:
a first antenna port for feeding microwave energy via a first feeding junction into a first pair of feed lines which extend in parallel along said first aperture slot, on each side thereof;
a second antenna port for feeding microwave energy via a second feeding junction into a second pair of feed lines which extend in parallel along said second aperture slot, on each side thereof, wherein said feed lines cross each other at a mutual distance in more than one point.

Surprisingly, by actually increasing the mutual coupling between the two feeds by increasing the number of crossing points from only one as in the prior art, a better performance can be achieved in terms of design parameters such as Return loss and isolation.

### BRIEF DESCRIPTION OF THE DRAWINGS

FIG. 1 illustrates an exploded view of an antenna element according to prior art,

FIG. 2 illustrates the feeds and the apertures of FIG. 1 from above,

FIG. 3 illustrates the arrangement of FIG. 2 in a more conceptual way,

FIG. 4 illustrates a configuration of an antenna element according to the invention,

FIG. 5 illustrates a configuration of an antenna element according to the invention,

FIG. 6 illustrates a configuration of an antenna element according to the invention,

FIG. 7 depicts a diagram of properties of an antenna according to the prior art,

FIG. 8 depicts a diagram of properties of an antenna according to the prior art,

FIG. 9 depicts a diagram of properties of an antenna according to the invention,

FIG. 10 illustrates a feeding network, comprising feeding means, such as cables, for feeding an aperture antenna element according to the invention, and

FIG. 11 illustrates an aperture antenna in accordance with the present invention.

### DETAILED DESCRIPTION OF PREFERRED EMBODIMENTS

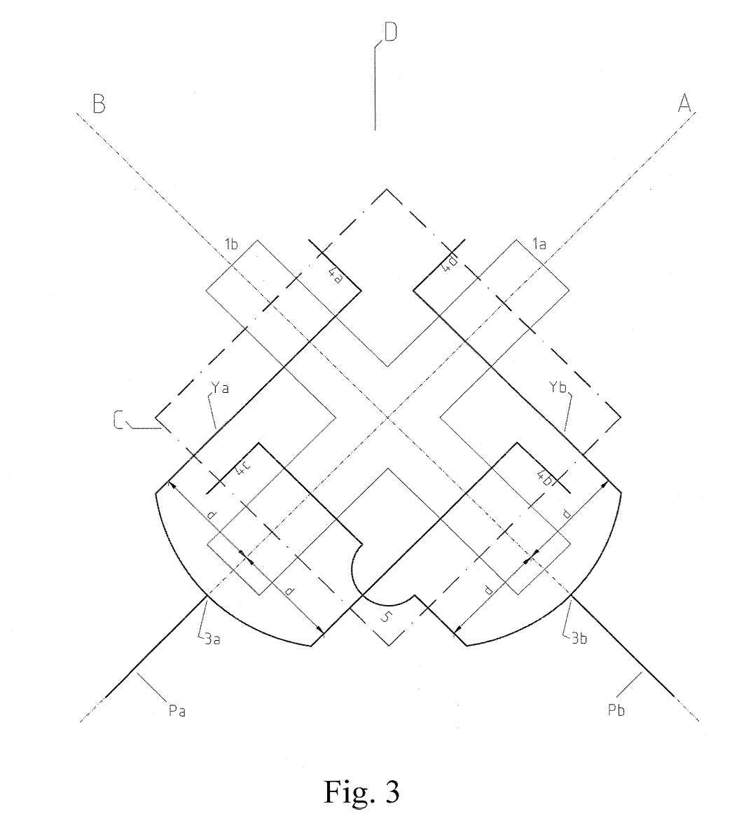

FIG. 3 shows a feeding arrangement according to prior art with a regular configuration.

One or more metallic patches C are fed by a cross shaped aperture in the ground plane.

A feeding arrangement D shown in FIG. 3 comprises a ground plane with a first aperture slot 1a and a second aperture slot 1b where the slots cross each other perpendicularly to form a cross shaped aperture in the ground plane. Furthermore, the aperture slots in FIG. 3 cross each other perpendicularly and centrally so as to form a symmetric configuration.

The feeding arrangement further comprises a feeding plane with a first antenna port Pa for feeding microwave energy via a first feeding junction 3a into a first pair of feed lines Ya which extend in parallel along the first aperture slot 1a on each side thereof, and a second antenna port Pb for feeding microwave energy via a second feeding junction 3b into a second pair of feed line Yb which extend in parallel along the second aperture slot 1b on each side thereof.

The feeding junctions 3a and 3b are arranged on a centre line, A and B, of their associated pair of feed lines, and hence are symmetrically arranged in respect to said associated pair of feed lines.

Furthermore, the pair of feed lines Ya and Yb extend in parallel and equidistant (with a distance d) along their respective aperture slots 1a and 1b, and on each side thereof, respectively. Moreover, each pair of feed lines, Ya and Yb, incorporates two stubs, 4a-4b and 4c-4d, of equal length.

The feed lines cross each other in one point 5 at a mutual distance from each other to avoid direct conductive connection between the feed lines. A common solution, as previously mentioned, is to use air as a dielectric between the feed lines and therefore an air-bridge is often employed, but a person skilled in the art realizes that the present invention is also applicable to solutions with other dielectric material in the crossing.

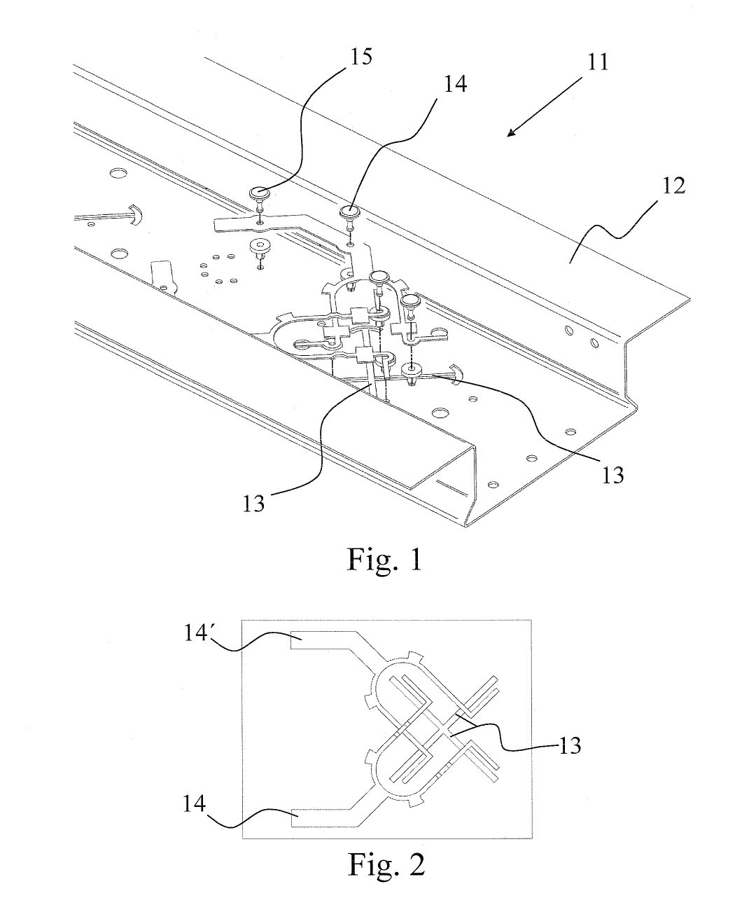

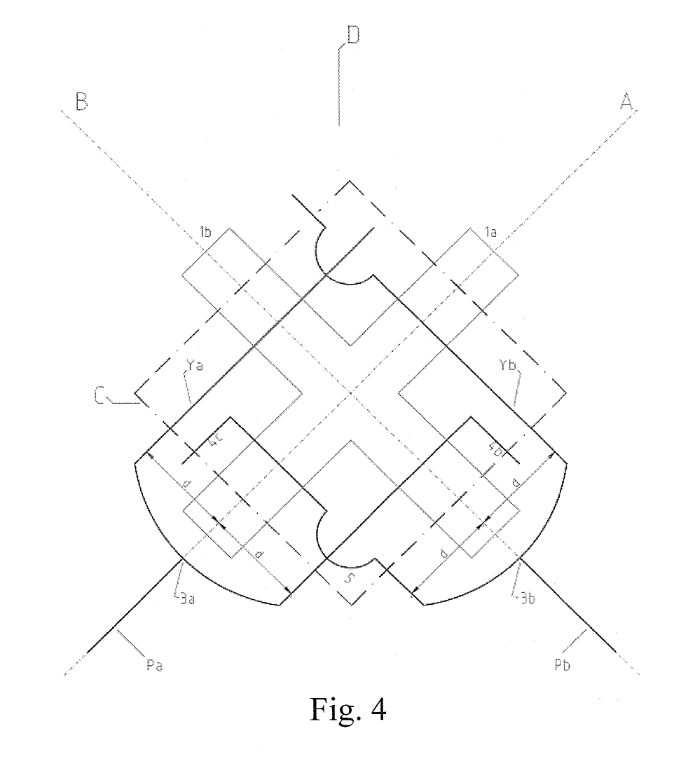

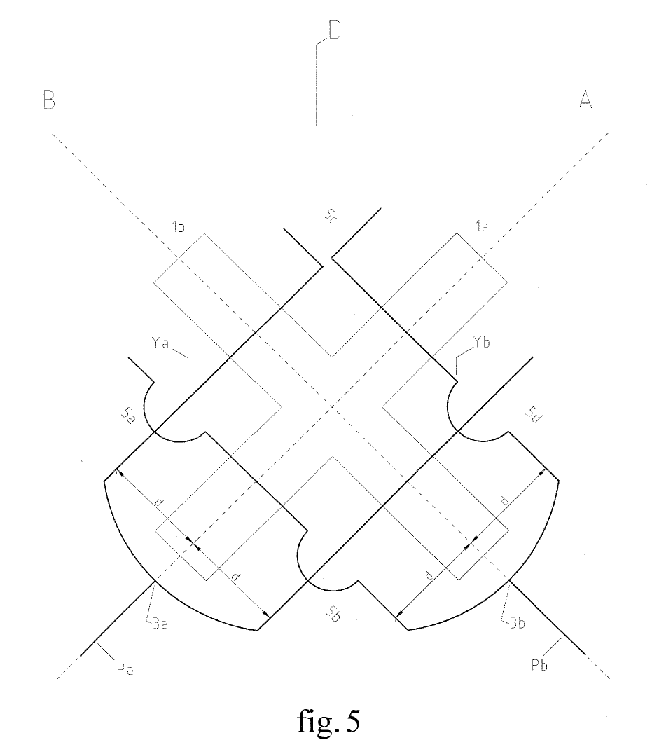

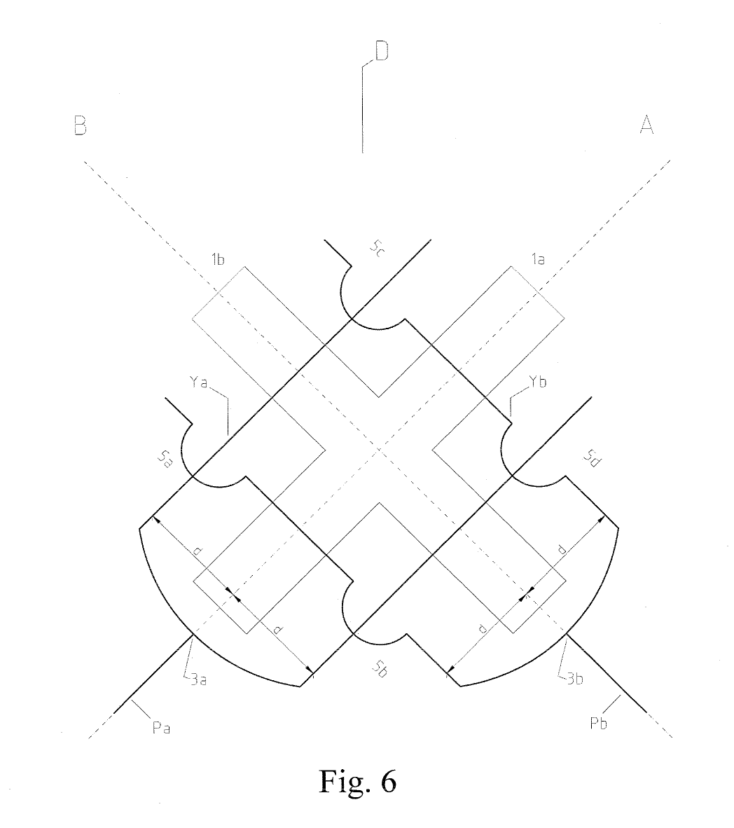

Instead of the prior art configuration according to FIGS. 1-3, the arrangement according to any of FIGS. 4-6 is proposed in accordance with the present invention. The difference between the feeding arrangement in FIG. 3 and those in FIGS. 4-6 is that the number of crossings are more than one. For instance in FIG. 4 there are two crossings; in FIG. 5 there are three crossings; while in FIG. 6 there are four crossings 5a-5d. It could be anticipated that increasing the number of crossings between the two feeds would actually deteriorate the performance of the antenna element, since the mutual coupling of the feeds should increase. This is the reason why the prior art is designed with only one crossing as in FIGS. 1-3. Unexpectedly, the performance of an antenna element having more than one crossing, as in FIGS. 4-6, is improved compared to the old design.

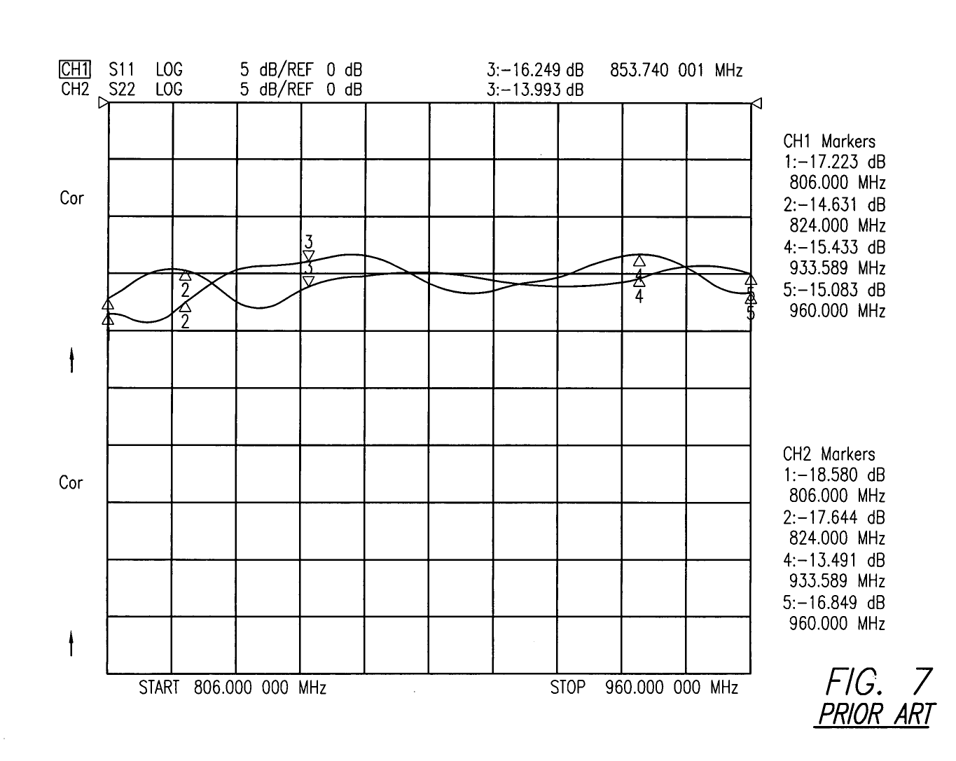

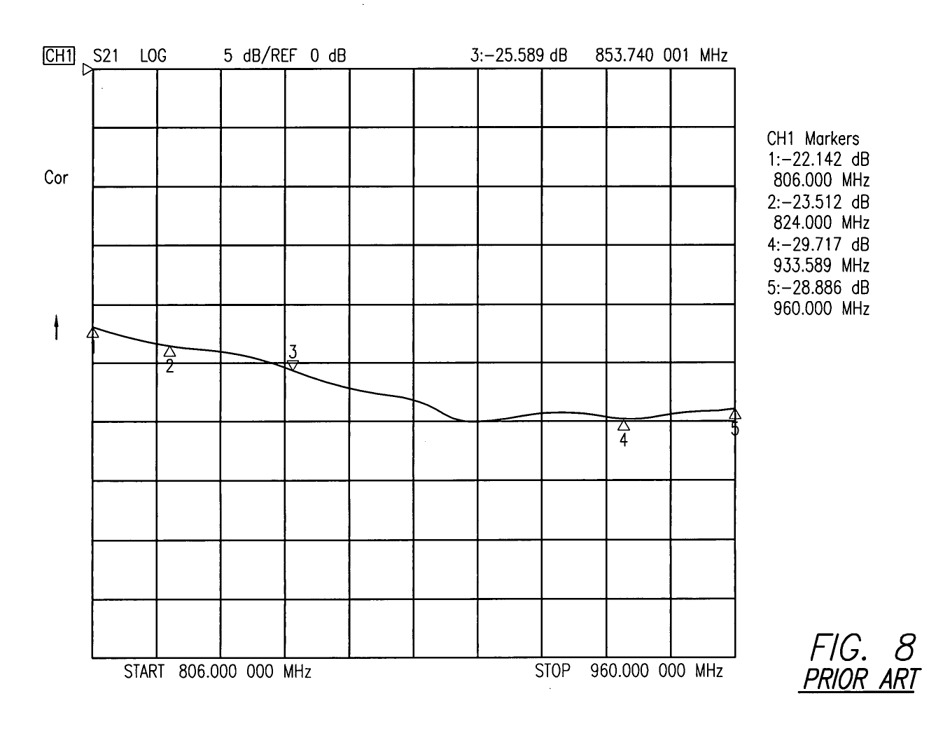

FIGS. 7 and 8 show best in practice found test results with the one crossing design of FIGS. 1-3, FIG. 7 shows that Return Loss of this design does not pass a requirement of RL<-14.0 dP. Further, FIG. 8 shows that Isolation of this design does not pass a requirement of >30 dB in a band of 806-960 MHz.

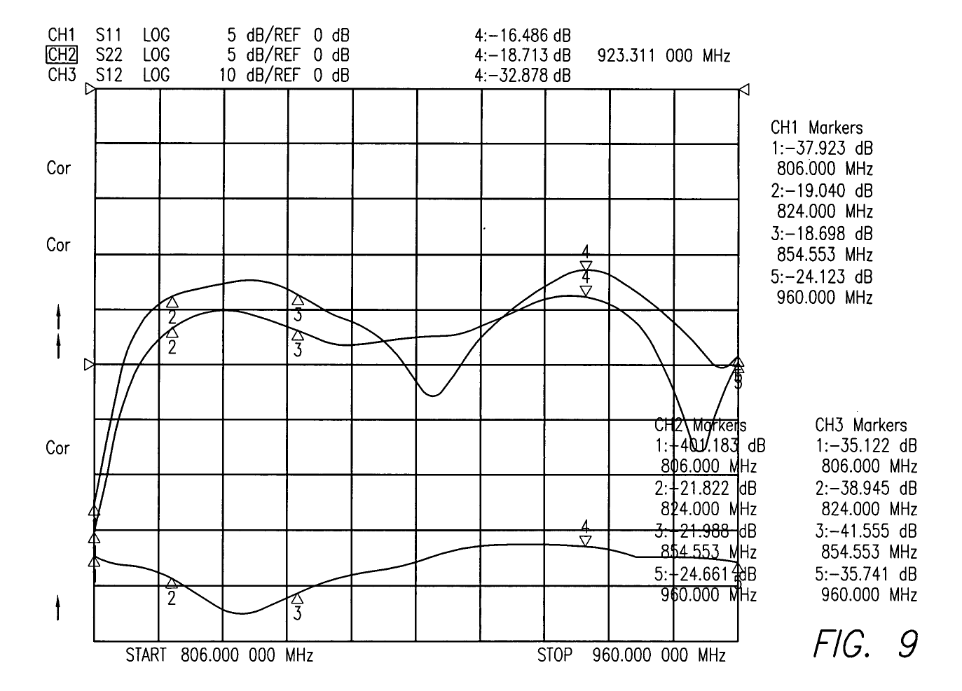

Turning now to results with the new design as embodied in FIG. 6, where one could have anticipated the worst performance due to the design of FIG. 6 having the highest number of crossings of the examples of the figures, namely four. However, surprisingly the results depicted in FIG. 9, indicates a satisfactory performance with Return Loss<-14.0 dB and Isolation>30 dB across the 806-960 MHz band. In FIG. 9, CH3 corresponds to the line at the bottom of the graph and CH1 corresponds to the line that is mostly above the other lines in the graph except for a bump in the middle of the CH1 line. CH1 and CH2 correspond to the return loss for the two feeds and CH3 is the isolation.

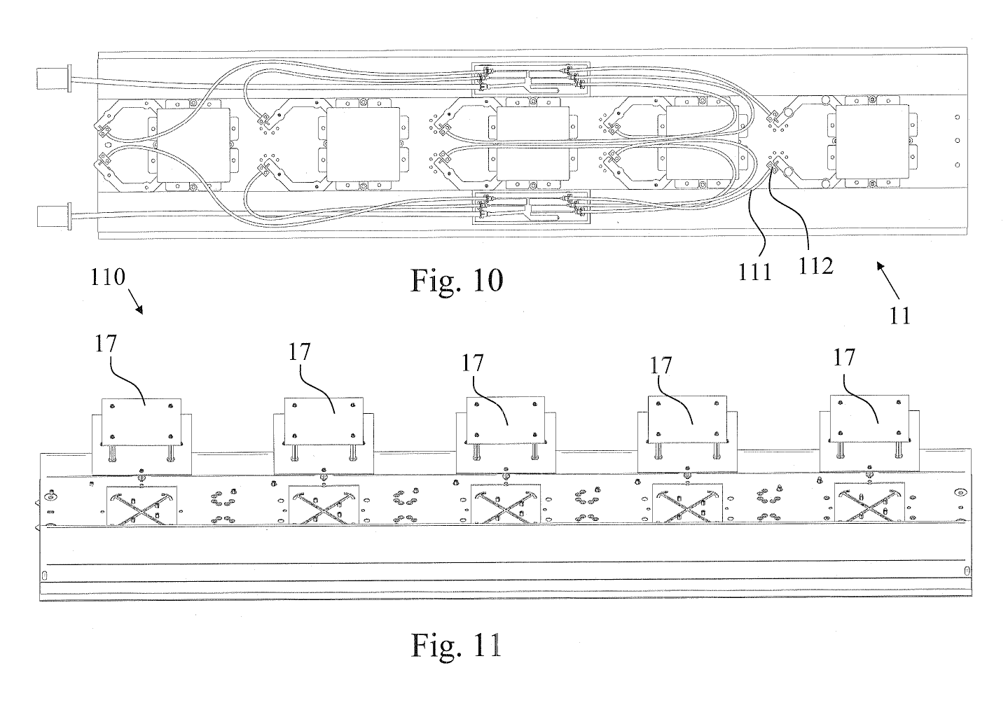

With reference now to FIG. 10, the feeding network, comprising feeding means 111, for example cables, for feeding the aperture antenna element 11 in accordance with the present invention, is shown. Each aperture antenna element 11 is feed by the feeding network, and thus connected to it by some suitable coupling means 112. The feeding network may be a conventional feeding network well known within the art.

With reference finally to FIG. 11, an aperture antenna 110 in accordance with the present invention is shown. The aperture antenna 110 comprises one or several aperture antenna elements 11 in accordance with the present invention. The aperture antenna 110 further preferably comprises equally many patches 17, for providing an aperture-coupled wide-band antenna.

To summarize, the present invention provides an improved aperture antenna element and aperture antenna, yielding better performance compared to the older design. Although the present invention has been shown and described by specific embodiments, many alterations and modifications are possible, as would be obvious to a person skilled in the art.

1. A dual polarized aperture coupled patch antenna element, including at least one antenna patch and a feeding arrangement, wherein said feeding arrangement comprises:
a ground plane including: a first aperture slot and a second aperture slot, where said aperture slots cross each other perpendicularly;
a feeding plane comprising sheet metal and including:
a first antenna port for feeding microwave energy via a first feeding junction into a first pair of feed lines which extend in parallel along said first aperture slot, on each side thereof;
a second antenna port for feeding microwave energy via a second feeding junction into a second pair of feed lines which extend in parallel along said second aperture slot, on each side thereof,
wherein said feed lines cross each other at a mutual distance in more than one point.

2. An element according to claim 1, wherein said feed lines cross each other at a mutual distance at two points.

3. An element according to claim 1, wherein said feed lines cross each other at a mutual distance at three points.

4. An element according to claim 1, wherein said feed lines cross each other at a mutual distance at four points.

5. An antenna, comprising:
a dual polarized aperture coupled patch antenna element, including at least one antenna patch and a feeding arrangement, wherein said feeding arrangement comprises:
a ground plane including: a first aperture slot and a second aperture slot, where said aperture slots cross each other perpendicularly;
a feeding plane comprising sheet metal and including:
a first antenna port for feeding microwave energy via a first feeding junction into a first pair of feed lines which extend in parallel along said first aperture slot, on each side thereof;
a second antenna port for feeding microwave energy via a second feeding junction into a second pair of feed lines which extend in parallel along said second aperture slot, on each side thereof,
wherein said feed lines cross each other at a mutual distance in more than one point.

6. An antenna according to claim 5, wherein said feed lines cross each other at a mutual distance at two points.

7. An antenna according to claim 5, wherein said feed lines cross each other at a mutual distance at three points.

8. An antenna according to claim 5, wherein said feed lines cross each other at a mutual distance at four points.
